(19) United States
(12) Patent Application Publication
(10) Pub. No.: US 2007/0143595 A1
(43) Pub. Date: Jun. 21, 2007

(54) Method of producing a digital certificate, and an associated digital certificate

(75) Inventor: Pierre Girard, La Destrousse (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 10/590,214

(22) PCT Filed: Feb. 25, 2005
(86) PCT No.: PCT/EP05/50829

§ 371 Date: Aug. 22, 2006

(30) Foreign Application Priority Data
Feb. 27, 2004 (FR) 0401976

(51) Int. Cl. H04L 9/00

(52) U.S. Cl. 713/156; 713/176

(57) ABSTRACT

In a method of producing a digital certificate, a certificate authority compiles a data set containing a public key and digital data that identifies the owner of the public key and an associated private key, and subsequently signs that data set to produce a digital certificate. The invention, the digital data also includes data that identifies a device for generating the private key and/or storing the private key on a support and/or signing with the private key. The method can be used to produce X509-type digital certificates.

In the field of secure electronic transactions, the invention concerns particularly the production of a digital certificate during which a certification authority groups together, in a data set, a public key and digital data comprising data identifying the proprietor of the said public key and an associated private key, and then signs the data set in order to produce a digital certificate.

Electronic transaction means here the transmission of a digital data set (a set that will be referred to as a message or electronic message for reasons of simplicity) in the broadest sense. It may be a case for example of the transmission of a deed of purchase or sale, the transmission of a request for access to an online service, the transmission of an electronically signed information message, etc.

Such transactions can be made secure by the use of enciphering and/or signing algorithms (for example the RSA algorithm) with asymmetric keys: a private key and a public key.

The private key is used by the sender for signing a message before sending. The private key is a characteristic of the person who sends a signed message, it is kept secret, for example in a memory of hardware owned by the sender of the message. The private key can thus be kept on an internal disc of a personal computer, in a memory of a SIM card (subscriber identification module) of a portable telephone, in a memory of a memory card or of a microprocessor card accessible in read mode by a personal computer by means of a card reader, etc.

The public key is used by the person receiving the message, in order to verify the authenticity of the signed message received and the identity of the sender of the message received.

The use of signing algorithms assumes, prior to any transmission, that the sender communicates his public key to the person for whom the transactions is intended. This communication may be direct: sending a message containing the key, sending a physical medium such as a memory or a disk on which the key is stored, etc. This communication can also take place by means of a public key infrastructure (or PKI) or certification infrastructure.

A public key infrastructure involves in particular a certification entity and a certifying third party, to permit consistency in the management of pairs of keys.

The certification entity is a standards body defining in particular the certification conditions, the data to be included in a certificate and the way in which the certificates produced are used. In a known manner, a certificate comprises a public key and data identifying one or more proprietors of the said public key and of the associated private key

The word proprietor must be understood here in the broad sense. The proprietor of the keys may of course be a physical person. However, the proprietor may also be hardware to which the pair of keys is attached. For example, in a large company owning several digital data transmission servers, one or more servers frequently “possess” their own keys.

Thus, and according to the instructions of the certification entity, the data identifying each proprietor may comprise the name of the user and/or his postal address and/or his bank details and/or identity card numbers and/or references identifying proprietary hardware.

One of the certificate formats frequently used is the X509 format, defined according to the standard Information Technology—Open Systems Interconnection—The Directory: Public-Key and Attribute Certificate Frameworks, dated March 2002, of the International Telecommunication Union. The X509 format comprising, for each certificate, the following parameters:
a reference number associated with the certificate,
an indication of the method used for the digital signing of a message,
the details of the sender of the certificate,
the period of validity of the certificate,
the details of the proprietor of the key,
the public key,
a set of N free use fields,
the signature of the sender of the certificate.

The certifying third party sends the digital certificates and makes them available to the public for consultation in a database containing a set of certificates. The certifying third party is thus responsible initially for collecting and verifying the information that is to appear in a certificate. Secondly, the certifying third party groups together the public key and the data identifying the proprietor of the said public key in a digital message that he signs with his own private key in order to form the digital certificate. Finally, the certifying third party makes the certificate available in a database.

By consulting the base of certificates, and if he trusts the certifying third party, a person will be able to authenticate the sender of a signed message that he has received or encipher a message intended for him, before validating a sale or not, authorising or not access to a site reserved for subscribers, etc.

The techniques for producing and making available digital certificates are today fairly widespread. They have made it possible to make electronic transactions secure to a certain extent in order to allow their development. The intervention of a certifying third party, the use of cryptographic algorithms and secure protocols for obtaining certificates makes it possible to guarantee the identity of the person who has requested a certificate on the basis of his public key.

However, a certificate does not guarantee that a message received has been signed by the proprietor of the private key associated with the public key and used for signing the message received. More precisely, a certificate does not guarantee that a private key used for the signature of a message has not been stolen or used unknown to its proprietor.

Stored on a personal computer, the private key is liable to be stolen or modified or used unknown to its owner by a malevolent third party, for example by means of a virus or a Trojan horse. To prevent this risk, specific equipment, such as memory cards associated with a card reader, has been developed to store in particular the private keys; a risk does however remain when the private key is read in the card and transmitted to a signature program present in the personal computer. To limit this risk further, microprocessor cards have been developed, which store not only the private key but also the signature method using the said private key, so that the private key is never accessible directly from outside, for example on an input/output terminal of the card.

Thus some current items of equipment and methods allow the diminution or even the elimination of the risks of theft or of the use of a private key unknown to its proprietor.

However, a distant third party who has access solely to a certificate associated with the private key is not able to estimate the risk that he is taking by accepting the electronic signature of a distant user. This of course limits the degree of confidence that a third party can have in a digital certificate or in a signed message received.

The aim of the invention is to resolve this problem by proposing a method of producing a certificate and an associated certificate containing information enabling a third party who receives a signed message to estimate the probability of the sender of the transaction indeed being the authentic proprietor of the private key used for the signature.

For this the invention proposes a method of producing a digital certificate during which a certification authority groups together, in a data set, a public key and digital data comprising data identifying the proprietor of the said public key and of an associated private key, and then signs the data set in order to produce a digital certificate.

According to the invention, the method is characterised in that the digital data also comprise data identifying means of generating the private key and/or means of storing the private key on a medium and/or means of signing with the private key.

The data identifying the means of generating the private key can for example comprise data identifying:
a method of generating the private key and/or
hardware on which the method of generating the private key is implemented, and/or
a place on which the method of generating the private key is implemented.

The data identifying the means of storing the private key can for their part comprise data identifying:
a method of storing the private key on a medium, and/or
hardware on which the method of storing the private key is implemented, and/or
a place on which the method of storing the private key is implemented, and/or
a storage medium on which the private key is stored.

Finally, the data identifying the signature means can for example comprise data identifying:
a signature method using the private key,
a memory medium on which the said signature method is stored.

The data identifying hardware or a storage medium comprise for example:
a reference identifying the said hardware or the said storage medium, and/or
an identification of a manufacturer of the said hardware or of the said storage medium, and/or
an indication of a security level of the said hardware or of the said storage medium defined according to a standard ISO 15408 dated 1.12.99.

The data identifying a method comprise:
a reference identifying the said method, and/or
an identification of an inventor of the said method, and/or
an indication of a security level of the said method according to ISO 15408.

The data identifying a place comprise:
an identification of the said place, and/or
an identification of a security level of the said place according to ISO 15408.

The invention also concerns a digital certificate comprising:
a public key,
data identifying a proprietor of the public key and of an associated private key, and
data identifying means of generating the private key and/or means of storing the private key on a medium and/or means of signature with the said private key.

In a preferred embodiment this certificate is of the X509 type according to a standard Information Technology—Open Systems Interconnection—The Directory: Public Key and Attribute Certificate Frameworks, dated March 2000, of the International Telecommunication Union. In the X509 certificate, a set of predefined free fields are used to store the digital data identifying:
a method of generating the private key, and/or
hardware on which the method of generating the private key is implemented, and/or
a place on which the method of generating the private key is implemented, and/or
a method of storing the private key on a medium, and/or
hardware on which the method of storing the private key is implemented, and/or
a place on which the method of storing the private key is implemented, and/or
a storage medium on which the private key is stored, and/or
a signature method using the private key, and/or
a storage medium on which the said signature method is stored.

The invention also concerns a method of using a digital certificate as described above, comprising the following steps consisting of:
receiving a message signed with a private key,
reading, in the digital certificate, data identifying means of generating the private key and/or means of storing the private key on a medium and/or means of signing with the private key,
deducing therefrom a probability of the said private key having been used by a legitimate proprietor of the said private key,
according to the said probability, accepting or refusing the electronic message.

It is possible for example to choose to accept a message only if the probability of the private key having been used by its legitimate proprietor is greater than a predefined value VB. The predefined value is chosen according to the level of security required for a transaction. It is for example possible to choose a predefined value proportional to the financial stakes relating to a transaction.

It is also possible to choose to:
accept the message if the probability is greater than a first value VB1,
request confirmation of the transaction if the probability lies between a first value VB1 and a second value VB2 less than the first, and
refuse the message if the probability is less than the second value.

To estimate the probability of the private key having been used by its legitimate proprietor, the information relating to the secret key present in the digital message is used.

In one example, the information present in the certificate and relating to the private key indicates that the private key has been generated and stored in a microprocessor card that also stores a signature method. The information relating to the private key also indicates that the generation of the key, its storage and the storage of the signature method were carried out within the factory itself that manufactured the card, a factory having a maximum certification level (in terms of security). In this case, a third party consulting the said certificate knows that there is a maximum probability (greater than the predefined value) of the private key having been used by its legitimate proprietor and he can deduce therefrom almost with certainty the identity of the sender of a signed transaction that he has received.

In another example, the information present in the certificate and relating to the private key indicates that the private key was generated in a point of sale of computer equipment, and that the private key and the signature method are stored on a hard disk of a personal computer. In this case, a third party consulting the said certificate knows that there is a high probability that the private key may have been stolen or used unknown to its proprietor. He can deduce therefrom that the identity of the sender of a signed transaction that he has received is not certain and consequently decide to refuse the transaction in order to avoid any risk.

1. A method of producing a digital certificate in which a certification authority performs the steps of grouping together, in a data set, a public key and digital data comprising data identifying the proprietor of said public key and of an associated private key, signing the data set in order to produce a digital certificate, and storing the signed data set in a computer-readable storage medium,
wherein the digital data also comprise data identifying at least one of means of generating the private key, means of storing the private key on a medium, and means of signing with the private key.

2. A method according to claim 1, in which the data identifying the means of generating the private key comprise data identifying:
a method of generating the private key and/or
hardware on which the method of generating the private key is implemented, and/or
a place on which the method of generating the private key is implemented.

3. A method according to claim 1, in which the data identifying the means of storing the private key comprise data identifying:
a method of storing the private key on a medium, and/or
hardware on which the method of storing the private key is implemented, and/or
a place on which the method of storing the private key is implemented, and/or
a storage medium on which the private key is stored.

4. A method according to claim 1, in which the data identifying the signature means comprise data identifying:
a signature method using the private key, and/or
a memory medium on which said signature method is stored.

5. A method according to claim 2, in which the data identifying hardware or a storage medium comprise:
a reference identifying said hardware or said storage medium, and/or
an identification of a manufacturer of said hardware or of said storage medium, and/or
an indication of a security level of said hardware or of said storage medium defined according to a standard ISO 15408.

6. A method according to claim 2, in which the data identifying a method comprise:
a reference identifying said method, and/or
an identification of an inventor of said method, and/or
an indication of a security level of said method according to ISO 15408.

7. A method according to, claim 2 in which the data identifying a place comprise:
an identification of said place, and/or
an identification of a security level of said place according to ISO 15408.

8. A digital certificate stored in a computer-readable medium, comprising:
a public key,
data identifying a proprietor of the public key and of an associated private key, and
data identifying at least one of means of generating the private keys means of storing the private key on a medium, and means of signature with said private key.

9. A certificate according to claim 8, of the X509 type according to a standard Information Technology—Open Systems Interconnection—The Directory: Public Key and Attribute Certificate Frameworks, dated March 2000, of the International Telecommunication Union, in which a set of predefined free fields are used to store the digital data identifying:
a method of generating the private key, and/or
hardware on which the method of generating the private key is implemented, and/or
a place on which the method of generating the private key is implemented, and/or
a method of storing the private key on a medium, and/or
hardware on which the method of storing the private key is implemented, and/or
a place on which the method of storing the private key is implemented, and/or
a storage medium on which the private key is stored, and/or
a signature method using the private key, and/or
a storage medium on which the said signature method is stored.

10. A method of using a digital certificate according to claim 8, comprising the following steps:
receiving a message signed with a private key,
reading, in the digital certificate, data identifying means of generating the private key and/or means of storing the private key on a medium and/or means of signing with the private key,
deducing therefrom a probability of said private key having been used by a legitimate proprietor of said private key,
according to said probability, accepting or refusing the electronic message.

11. A method according to claim 10, in which the message is accepted solely if the probability of the said key having been used by its legitimate proprietor is greater than a predefined value.

12. A method according to claim 10, in which:
the message is accepted if the probability is greater than a first value (VB1),
a confirmation of the said message is requested if the probability is between the first value (VB1) and a second value (VB2) less than the first value, and
the message is refused if the probability is less than the second value (VB2).

13. A method according to claim 2, in which the data identifying the means of storing the private key comprise data identifying:
a method of storing the private key on a medium, and/or
hardware on which the method of storing the private key is implemented, and/or
a place on which the method of storing the private key is implemented, and/or
a storage medium on which the private key is stored.

14. A method according to claim 2, in which the data identifying the signature means comprise data identifying:
a signature method using the private key, and/or a memory medium on which said signature method is stored.

15. A method according to claim 3, in which the data identifying the signature means comprise data identifying:
a signature method using the private key, and/or
a memory medium on which said signature method is stored.

16. A method according to claim 3, in which the data identifying hardware or a storage medium comprise:
a reference identifying said hardware or said storage medium, and/or
an identification of a manufacturer of said hardware or of said storage medium, and/or
an indication of a security level of said hardware or of said storage medium defined according to a standard ISO 15408.

17. A method according to claim 4, in which the data identifying hardware or a storage medium comprise:
a reference identifying said hardware or said storage medium, and/or
an identification of a manufacturer of said hardware or of said storage medium, and/or
an indication of a security level of said hardware or of said storage medium defined according to a standard ISO 15408.

18. A method according to claim 3, in which the data identifying a method comprise:
a reference identifying said method, and/or
an identification of an inventor of said method, and/or
an indication of a security level of said method according to ISO 15408.

19. A method according to claim 4, in which the data identifying a method comprise:
a reference identifying said method, and/or
an identification of an inventor of said method, and/or
an indication of a security level of said method according to ISO 15408.

20. A method according to claim 5, in which the data identifying a method comprise:
a reference identifying said method, and/or
an identification of an inventor of said method, and/or
an indication of a security level of said method according to ISO 15408.
